(19) United States
(12) Patent Application Publication
(10) Pub. No.: US 2014/0379467 A1
(43) Pub. Date: Dec. 25, 2014

(54) In-Store Promotion Techniques For Electronic Devices

(71) Applicant: barnesandnoble.com llc, New York, NY (US)

(72) Inventors: Chen-Je Huang, Menlo Park, CA (US); Shaun Saperstein, San Carlos, CA (US)

(73) Assignee: barnesandnoble.com llc, New York, NY (US)

(21) Appl. No.: 13/924,362

(22) Filed: Jun. 21, 2013

(51) Int. Cl. G06Q 30/02

(52) U.S. Cl. CPC G06Q 30/0255
USPC 705/14.53

(57) ABSTRACT

In-store promotion techniques for alerting an electronic device user of local in-store promotional events are disclosed. The in-store promotion mode may determine the user's taste profile based on the user's shopping cart, wish list, search history, purchase history, content ratings, favorite authors, and/or event preferences. A promotion notification relating to promotions matching the user's taste profile may be displayed to the user, for example, with a pop-up window, a message on the user's welcome screen or home page, or other notification displayed to the user on the device screen. The promotion notifications may be limited to promotional events taking place at the user's local retail store, and the user may designate the local retail store. The promotion notification may be a generic message notifying the user of the existence of a promotion, and upon visiting the retail store a welcome message including the promotion details may be displayed on the device.

### FIELD OF THE DISCLOSURE

This disclosure relates to electronic display devices, and more particularly, to promotional techniques targeted toward electronic device users.

### BACKGROUND

Electronic display devices such as tablets, eReaders, mobile phones, smart phones, personal digital assistants (PDAs), and other such touch screen electronic display devices are commonly used for displaying consumable content. The content may be, for example, an eBook, an online article or blog, images, a movie or video, a map, just to name a few types. Such display devices are also useful for displaying a user interface that allows a user to interact with an application running on the device. The user interface may include, for example, one or more touch screen controls and/or one or more displayed labels that correspond to nearby hardware buttons. The touch screen display may be backlit or not, and may be implemented for instance with an LED screen or an electrophoretic display. Such devices may also include other touch sensitive surfaces, such as a track pad (e.g., capacitive or resistive touch sensor) or touch sensitive housing (e.g., acoustic sensor).

### BRIEF DESCRIPTION OF THE DRAWINGS

FIGS. 1a-b illustrate an example electronic touch screen device having an in-store promotion mode configured in accordance with an embodiment of the present invention.

FIGS. 1 c-d illustrate example configuration screen shots of the user interface of the electronic touch screen device shown in FIGS. 1 a-b, configured in accordance with an embodiment of the present invention.

FIG. 2a illustrates a block diagram of an electronic touch screen device configured in accordance with an embodiment of the present invention.

FIG. 2b illustrates a block diagram of a communication system including the electronic touch screen device of FIG. 2a, configured in accordance with an embodiment of the present invention.

FIGS. 3a-b illustrate an example in-store promotion mode of an electronic touch screen device, in accordance with an embodiment of the present invention.

FIGS. 4a-b illustrate an example in-store promotion mode of an electronic touch screen device, in accordance with another embodiment of the present invention.

FIG. 5 illustrates a method for providing an in-store promotion mode in an electronic touch screen device, in accordance with an embodiment of the present invention.

### DETAILED DESCRIPTION

In-store promotion techniques for alerting an electronic device user of local in-store promotional events are disclosed. The in-store promotion mode may determine the user's taste profile based on, for example, the user's reading history, shopping cart, wish list, search history, purchase history, content ratings, favorite authors, browser behavior, and/or event preferences. A promotion notification relating to any promotions matching the user's taste profile may be displayed to the user with a pop-up window, a message on the user's welcome screen or home page, or any other notification displayed to the user on the device screen. In some cases, the user may configure how the promotion notifications will be displayed, as well as which types of promotions will be advertised with the in-store promotion mode. The promotion notifications may be limited to promotional events taking place at the user's local retail store. In some cases, the user may select the local retail store, or the device may automatically detect the closest retail store. In order to redeem the promotion, the user must visit the retail store. The promotion notification may be a generic message notifying the user of the existence of a promotion, and upon visiting the retail store a welcome message including the promotion details may be displayed on the device.

General Overview

As previously explained, electronic display devices such as tablets, eReaders, and smart phones are commonly used for displaying user interfaces and consumable content. The user of such devices can typically consume and purchase digital content with relative ease. In some instances, special promotions and/or events that may interest the user may be going on at local bookstores. While advertising techniques exist for notifying potential customers of sales events, an electronic device having an in-store promotion mode as described herein may provide a more customized and personal or otherwise positive user notification experience.

Thus, and in accordance with an embodiment of the present invention, in-store promotion techniques are disclosed for notifying the user of an electronic device of an in-store promotion that may be redeemed by visiting a physical retail store. The in-store promotion techniques described herein can be used, for example, to encourage electronic device users to visit a physical bookstore (or other content provider, such as music, video, software, and gaming stores) and create a strong connection between the electronic devices and the physical retail stores. Promotions may be triggered and shown to the user if, for instance, a match is detected between the user's interests, favorite authors, or wish-listed items and in-store promotions. In some cases, the promotions may include discounts that can be triggered by being in physical proximity to the nearest store (e.g., based on geolocation data) or connected to a store's wireless network, or actual events such as author's readings related to the user's taste profile. In one specific example, the user likes the author Danielle Steel and may receive a promotion saying that a special offer may be claimed on content by that author if they visit their local bookstore. In such an example, once in the bookstore, the user may receive a 30% discount on all books or eBooks by Danielle Steel. In another example embodiment, in order to encourage the user to visit the physical store (or a partner store), the promotion preference may be transferable from one electronic device (e.g., an eReader) to an eReader application on other mobile devices (e.g., a smartphone). In such an example, when the user walks by a physical store, a different notification may be displayed based on the user's preference with respect to the given devices, in effort to encourage that person to visit the store. As will be appreciated, note that the techniques provided herein can also be used with respect to a so-called partner store based on an established business alliance. For example, when Danielle Steel has a new book, the users can bring the device and read free at a coffee shop having a business alliance with the bookseller selling the new Danielle Steel book.

In one example embodiment, only promotions relevant to the user's interests are displayed through the in-store promotion mode. In such embodiments, the user's preferences may be determined based on the user's reading history, search history, purchase history, prior content ratings, wish list, event preferences, browser behavior, or other features of the user's taste profile. Local promotions may include eBook sales, book sales, magazine sales, author signings (or other artist/performer, etc), book readings, or other events at the user's local store or other stores nearby. In some cases, the user may select a local store using an in-store promotion mode configuration sub-menu or the device may determine the closest store to the user based on a local area network (LAN) to which the device is connected or a geolocation of the device. In some embodiments, the retail store running the in-store promotion can be any one of a specific chain of stores (e.g., any Barnes & Noble retail store), a specific local store (e.g., the closest Barnes & Noble store to the user's home address), a partner store (e.g., a coffee shop having a business agreement with Barnes & Noble), or any store supporting content that may be consumed on the user's eReader or electronic device (e.g., any store licensed to sell content that can be downloaded and consumed on a NOOK® tablet).

In some cases, the promotion notification may include a pop-up message displayed on the device screen once an in-store promotion begins, a message displayed on the device's home screen or the user's customizable welcome screen, or any other notification displayed to the user on the device screen. In some embodiments, the promotion notification may be accompanied by an animation or sound effect that may be user configurable or hard coded. In some embodiments, the promotion notification may be a generic message notifying the user of a sale or other event at a specific local store. In such embodiments, the user may need to enter the physical store in order to learn the details of the sale or event. In other embodiments, the promotion notification may include the details of a promotion but require the user to visit the physical store in order to redeem the promotion. Note that the promotion notification can be provided to the user, for example, via any number of suitable computing devices such as a tablet, eReader, smart phone, laptop, desktop, smart TV, gaming console or any other networked computing device.

In one embodiment, if the user has not visited the local store to redeem the promotion and the promotion is about to expire, the in-store promotion mode may display a reminder message to the user. In some cases a promotion may last for limited time and reminder message may help the user take advantage of the promotion before it expires. In one embodiment, the in-store promotion may include a sale on digital content and the digital content may be saved on a remote server. In such an embodiment, the user's electronic device may connect to the server via the Internet and/or other communication network. When the user visits the physical store and the promotion details are displayed, the device may be connected to the remote server through the store's local area network that is operatively coupled to the Internet or other network upon which the server resides thus allowing unlimited in-store reading of the eBooks that are on sale, in some embodiments. Although the example of eBooks is used throughout this disclosure, it is appreciated that other forms of digital content (e.g., digital magazines, videos, music, software applications, games, etc) or other non-digital content that may be sold at a retail store can be promoted through the in-store promotion techniques described herein.

Architecture

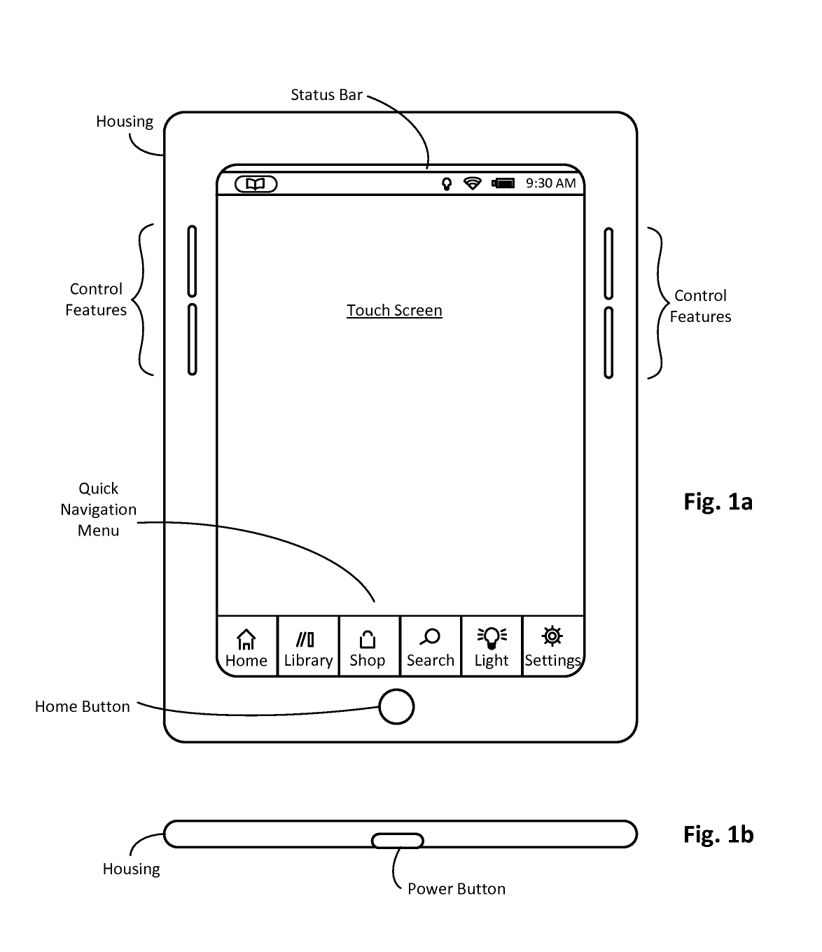

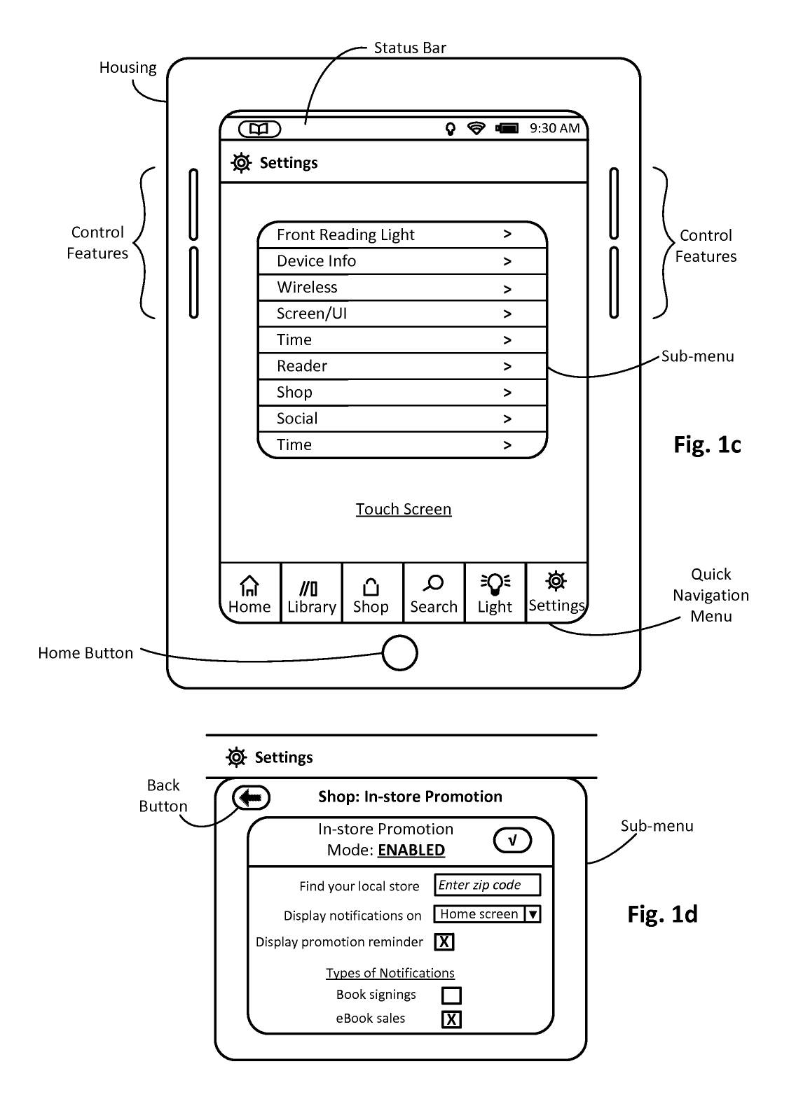

FIGS. 1 a-b illustrate an example electronic touch sensitive device having an in-store promotion mode configured in accordance with an embodiment of the present invention. As can be seen, in this example embodiment, the touch sensitive surface is a touch screen display. The device could be, for example, a tablet such as the NOOK® tablet or eReader by Barnes & Noble. In a more general sense, the device may be any electronic device having a touch sensitive user interface for detecting direct touch or otherwise sufficiently proximate contact, and capability for displaying content to a user, such as a mobile phone or mobile computing device such as a laptop, a desktop computing system, a television, a smart display screen, or any other device having a touch sensitive display or a non-sensitive display screen that can be used in conjunction with a touch sensitive surface. As will be appreciated in light of this disclosure, the claimed invention is not intended to be limited to any specific kind or type of electronic device or form factor.

As can be seen with this example configuration, the device comprises a housing that includes a number of hardware features such as a power button, control features, and a press-button (sometimes called a home button herein). A user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI features, or different UI features altogether, depending on the target application of the device. Any such general UI controls and features can be implemented using any suitable conventional or custom technology, as will be appreciated.

The hardware control features provided on the device housing in this example embodiment are configured as elongated press-bars and can be used, for example, to page forward (using the top press-bar) or to page backward (using the bottom press-bar), such as might be useful in an eReader application. The power button can be used to turn the device on and off, and may be used in conjunction with a touch-based UI control feature that allows the user to confirm a given power transition action request (e.g., such as a slide bar or tap point graphic to turn power off). Numerous variations will be apparent, and the claimed invention is not intended to be limited to any particular set of hardware buttons or UI features, or device form factor.

In this example configuration, the home button is a physical press-button that can be used as follows: when the device is awake and in use, pressing the button will display the quick navigation menu, which is a toolbar that provides quick access to various features of the device. The home button may also be configured to cease an active function that is currently executing on the device (such as an in-store reading application), or close a configuration sub-menu that is currently open. The button may further control other functionality if, for example, the user presses and holds the home button. For instance, an example such push-and-hold function could engage a power conservation routine where the device is put to sleep or an otherwise lower power consumption mode. So, a user could grab the device by the button, press and keep holding as the device is stowed into a bag or purse. Thus, one physical gesture may safely put the device to sleep. In such an example embodiment, the home button may be associated with and control different and unrelated actions: 1) show the quick navigation menu; 2) exit a configuration sub-menu; and 3) put the device to sleep. As can be further seen, the status bar may also include a book icon (upper left corner). In some cases, selecting the book icon may provide bibliographic information on the content or provide the main menu or table of contents for the book, movie, playlist, or other content.

In one particular embodiment, an in-store promotion mode configuration sub-menu, such as the one shown in FIG. 1d, may be accessed by selecting the Settings option in the quick navigation menu which causes the device to display the general sub-menu shown in FIG. 1c. From this general sub-menu, the user can select any one of a number of options, including one designated Shop in this specific example case. Selecting this sub-menu item may cause the configuration sub-menu of FIG. 1d to be displayed, in accordance with an embodiment. In other example embodiments, selecting the Shop option may present the user with a number of additional sub-options, one of which may include a so-called “in-store promotion” option, which may then be selected by the user so as to cause the in-store promotion mode configuration sub-menu of FIG. 1d to be displayed. Any number of such menu schemes and nested hierarchies can be used, as will be appreciated in light of this disclosure. In other example embodiments, the in-store promotion mode is hard-coded such that no configuration sub-menus are needed or otherwise provided (e.g., notifying the user of local promotions as described herein, with no user configuration needed). The degree of hard coding versus user-configurability can vary from one embodiment to the next, and the claimed invention is not intended to be limited to any particular configuration scheme of any kind, as will be appreciated.

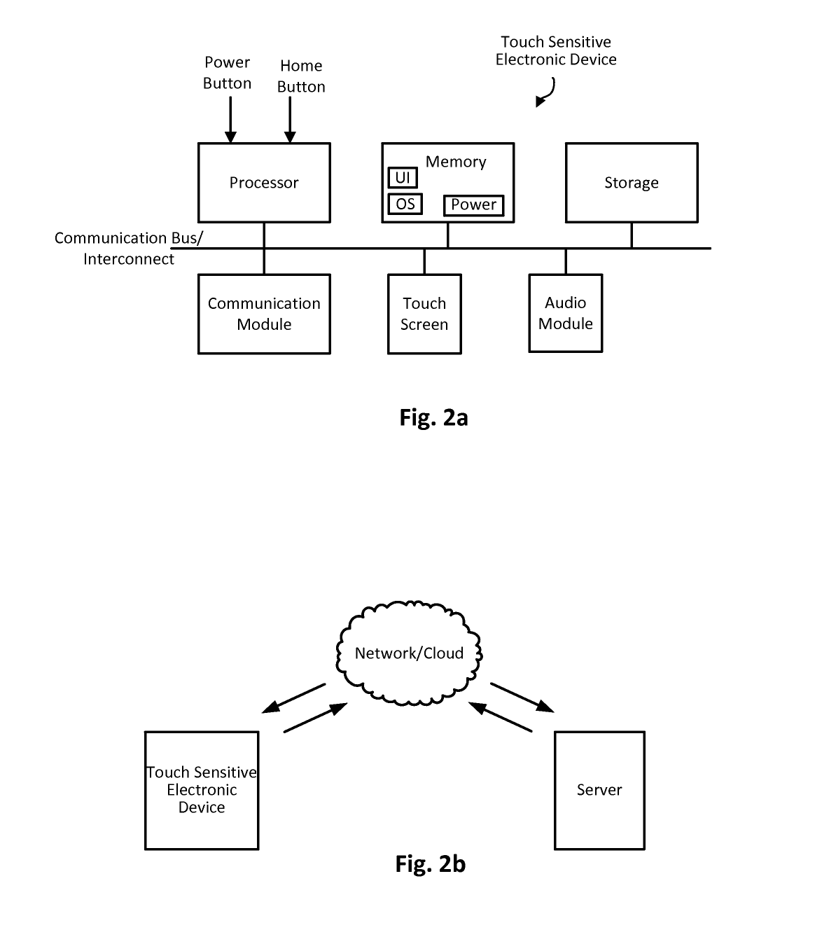

As will be appreciated, the various UI control features and sub-menus displayed to the user are implemented as touch screen controls in this example embodiment. Such UI screen controls can be programmed or otherwise configured using any number of conventional or custom technologies. In general, the touch screen display translates a touch (direct or hovering, by a user's hand, a stylus, or any other suitable implement) in a given location into an electrical signal which is then received and processed by the device's underlying operating system (OS) and circuitry (processor, display controller, etc.). In some instances, note that the user need not actually physically touch the touch sensitive device to perform an action. For example, the touch screen display may be configured to detect input based on a finger or stylus hovering over the touch sensitive surface (e.g., within 3 centimeters of the touch screen or otherwise sufficiently proximate to be detected by the touch sensing circuitry). Additional example details of the underlying OS and circuitry in accordance with some embodiments will be discussed in turn with reference to FIG. 2a.

The touch sensitive surface (or touch sensitive display, in this example case) can be any surface that is configured with touch detecting technologies, whether capacitive, resistive, acoustic, active-stylus, and/or other input detecting technology, including direct contact and/or proximate contact. In some embodiments, the screen display can be layered above input sensors, such as a capacitive sensor grid for passive touch-based input, such as with a finger or passive stylus contact in the case of a so-called in-plane switching (IPS) panel, or an electro-magnetic resonance (EMR) sensor grid for sensing a resonant circuit of a stylus. In some embodiments, the touch sensitive display can be configured with a purely capacitive sensor, while in other embodiments the touch screen display may be configured to provide a hybrid mode that allows for both capacitive input and EMR input, for example. In still other embodiments, the touch sensitive surface is configured with only an active stylus sensor. Numerous touch screen display configurations can be implemented using any number of known or proprietary screen based input detecting technologies. In any such embodiments, a touch sensitive controller may be configured to selectively scan the touch sensitive surface and/or selectively report user inputs detected directly on or otherwise sufficiently proximate to (e.g., within a few centimeters, or otherwise sufficiently close so as to allow detection) the detection surface (or touch sensitive display, in this example case).

As previously explained, and with further reference to FIGS. 1 c and 1d, once the Settings sub-menu is displayed (FIG. 1 c), the user can then select the Shop option. In response to such a selection, the in-store promotion mode configuration sub-menu shown in FIG. 1d can be provided to the user, in accordance with one such example embodiment. The user can configure a number of features with respect to the in-store promotion mode, in this example case. For instance, the configuration sub-menu includes a UI check box that when checked or otherwise selected by the user, effectively enables the in-store promotion mode (shown in the enabled state); unchecking the box disables the function. Other embodiments may have the in-store promotion mode always enabled, or enabled by a physical switch or button located on the device, for example. In some cases, the user may identify the closest bookstore or the store that the user most frequently visits. In this particular example, the user may enter their zip code and discover the closest store or stores. Identifying the user's local store allows the in-store promotion mode to notify the user of promotions and/or events at the local store or other stores close by. In some cases, the user may desire to specify where the in-store promotion notification will be displayed on the device. For instance, the notification may be displayed to the user whenever the promotion begins regardless of what application may be running on the device. In such an example, the notification may pop up on the device screen while the user is reading an eBook or surfing the web. In another embodiment, the user may not want to be interrupted while another application is running and may specify that the promotion notification be displayed on the device's home screen only. In this particular example, the user has configured the in-store promotion notification to be displayed on the home screen by selecting the appropriate option from a drop-down menu. Other locations where a notification may appear may include the navigation menu, a daily welcome page, the unlock screen, a status bar or banner on the top of the device screen, or any other suitable location. Furthermore, in some embodiments the user may wish to only receive notifications regarding certain types of local promotions or events. In this particular example, the user wishes to receive notifications regarding local in-store eBook sales but not book signing events and has indicated this by selecting the appropriate UI check box. As will be appreciated, additional notification types may be displayed to the user in some embodiments, and the present invention is not intended to be limited to any particular type of in-store promotion or event.

As can be further seen, a back button arrow UI control feature may be provisioned on the screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. The configuration sub-menu shown in FIG. 1 d is presented merely as an example of how an in-store promotion mode may be configured by the user, and numerous other configurable or hard-codable aspects will be apparent in light of this disclosure. Note that in some embodiments the in-store promotion mode may be visually and/or aurally demonstrated or otherwise confirmed to the user via animations and/or sound effects. Such animations and sound effects may be used to provide clarity to the function being performed or otherwise enhance the user experience. In some embodiments, such animations and sound effects may be user-configurable, while in other embodiments they are hard-coded.

FIG. 2a illustrates a block diagram of an electronic touch screen device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc). The touch screen and underlying circuitry is capable of translating a user's contact (direct or proximate) with the touch screen into an electronic signal that can be manipulated or otherwise used to trigger a specific user interface action, such as those provided herein. The principles provided herein equally apply to any such touch sensitive devices. For ease of description, examples are provided with touch screen technology.

In this example embodiment, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc), and encoded on a machine readable medium, that when executed by the processor (and/or co-processors), carries out the functionality of the device including a UI having an in-store promotion mode as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., Texas Instruments OMAP4, dual-core ARM Cortex-A9, 1.5 GHz), and may include one or more co-processors or controllers to assist in device control. In this example case, the processor receives input from the user, including input from or otherwise derived from the power button and the home button. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory). The display can be implemented, for example, with a 7 to 9 inch 1920×1280 IPS LCD touchscreen touch screen, or any other suitable display and touchscreen interface technology.

The communications module can include, for instance, any suitable 802.11b/g/n WLAN chip or chip set, which allows for connection to a local network, and so that content can be exchanged between the device and a remote system (e.g., content provider or repository depending on the application of the device). In some specific example embodiments, the device housing that contains all the various componentry measures about 7″ to 9″ high by about 5″ to 6″ wide by about 0.5″ thick, and weighs about 7 to 8 ounces. Any number of suitable form factors can be used, depending on the target application (e.g., laptop, desktop, mobile phone, etc). The device may be smaller, for example, for smartphone and tablet applications and larger for smart computer monitor and laptop and desktop computer applications.

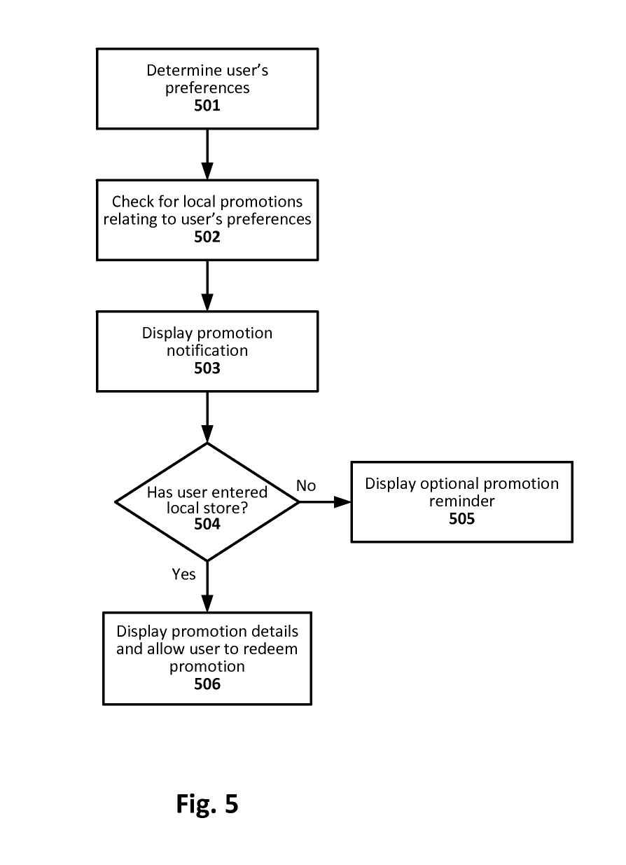

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured as typically done, such as to automatically transition the device to a low power consumption or sleep mode after a period of non-use. A wake-up from sleep mode can be achieved, for example, by a physical button press and/or a touch screen swipe or other action. The user interface (UI) module can be, for example, based on touchscreen technology and the various example screen shots and use-case scenarios shown in FIGS. 1a, 1c-d, 3a-b, and 4a-b, and in conjunction with the in-store promotion methodologies demonstrated in FIG. 5, which will be discussed in turn. The audio module can be configured to speak or otherwise aurally present, for example, an in-store promotion notification or other textual content, and/or to provide verbal and/or other sound-based cues and prompts to guide the in-store promotion process, as will be appreciate in light of this disclosure. Numerous commercially available text-to-speech modules can be used, such as Verbose text-to-speech software by NCH Software. In some example cases, if additional space is desired, for example, to store digital books or other content and media, storage can be expanded via a microSD card or other suitable memory expansion technology (e.g., 32 GBytes, or higher). Further note that although a touch screen display is provided, other embodiments may include a non-touch screen and a touch sensitive surface such as a track pad, or a touch sensitive housing configured with one or more acoustic sensors, etc.

Client-Server System

FIG. 2b illustrates a block diagram of a communication system configured in accordance with an embodiment of the present invention. As can be seen, the system generally includes an electronic touch sensitive device (such as the one in FIG. 2a) that is capable of communicating with a server via a network/cloud. In this example embodiment, the electronic touch sensitive device may be, for example, an eBook reader, a mobile cell phone, a laptop, a tablet, desktop, or any other computing device. Note that multiple user computing devices may be involved in the notification and in-store phases of the methodologies provided herein, and the notification portion does not necessarily need to be provided on a touch screen device or even a mobile computing device. For instance, the user could receive the notification of an in-store promotion on a set of designated devices (e.g., as determined by user configuration) that include a smartphone, a tablet, and a smart TV (e.g., so if the user is watching TV when the notification is announced, he/she will receive it while watching). Once notified, the user can grab their preferred mobile computing device and proceed to the store location if interested in the promotion. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by performing a desired function or providing the user with requested or otherwise recommended content. In some such embodiments, the server is configured to remotely provision an in-store promotion mode as provided herein to the computing device (e.g., via JavaScript or other browser based technology). In other embodiments, portions of the in-store promotion methodology can be executed on the server and other portions of the methodology can be executed on the device. Numerous server-side/client-side execution schemes can be implemented to facilitate an in-store promotion mode in accordance with an embodiment, as will be apparent in light of this disclosure.

In-Store Promotion Mode Examples

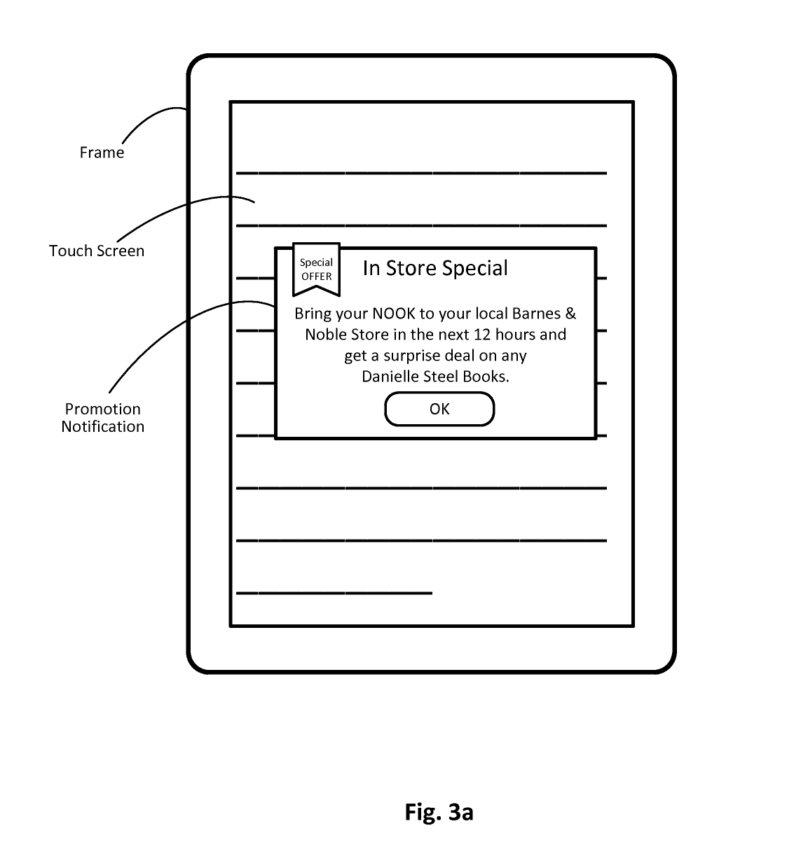

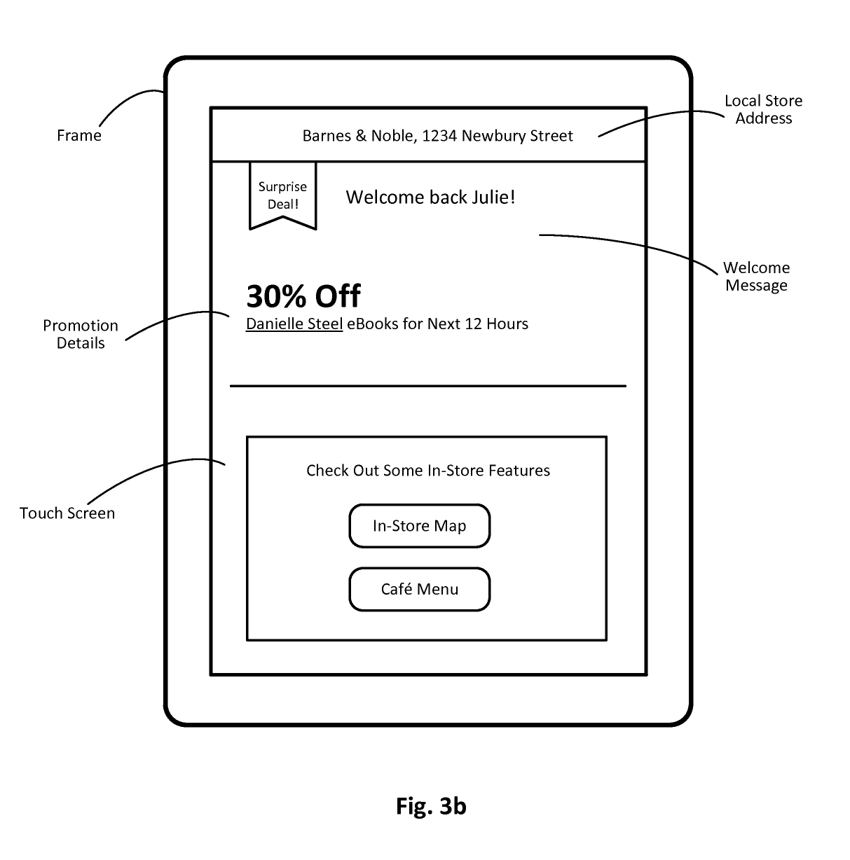

FIGS. 3a-b collectively illustrate an example in-store promotion mode that can be applied to a touch sensitive electronic device, in accordance with an embodiment of the present invention. Generally: FIG. 3a shows an electronic touch sensitive device displaying an example in-store promotion notification; and FIG. 3b shows an electronic touch sensitive device displaying the in-store promotion details.

FIG. 3a shows the device frame surrounding the touch screen of the electronic device and the device is displaying a promotion notification to the user. In this example, the promotion notification is included in a pop-up window that appears once the in-store promotion begins. In one embodiment, the device is connected to the Internet and can track in-store promotions online in order to notify the user of sales, book signings, or other in-store events at the user's local store. In this particular example, the pop-up window is displayed while the user is reading content using an eReader application, while in other embodiments the notification may be configured to not interrupt the user while another application is running. Furthermore, the promotion notification in this example embodiment is a generic notification that tells the user that for the next 12 hours there will be an in-store deal on books by Danielle Steel, but the notification does not tell the user what the deal will be. In order to discover the details regarding the promotion and receive the discount, the user must visit the physical bookstore. In accordance with some embodiments, the promotion is not offered to the general public and in one specific case is personalized for and only sent to one user. In one such case, the promotion is specifically based on and customized to the user's taste profile. In other such embodiments, the promotion may be offered to a subset of known customers of the retail store that might be interested in the promotion, but not all of the known customers that might be interested. Numerous other variations of selectively providing a highly targeted promotion will be apparent in light of this disclosure. Further note that metrics indicative of success (or failure) associated with a given promotion campaign can be tracked and parameters of that promotion can be refined accordingly, or highly targeted promotions can be expanded to one or more other selected customers that are similarly situated.

FIG. 3b shows the device is displaying the promotion details to the user upon entering the physical bookstore. In one embodiment, once the device is activated inside the bookstore it connects to the store's wireless network and displays the promotion details to the user. In this particular embodiment, the promotion is a 30% sale on Danielle Steel eBooks for the next 12 hours. In this example, the device also displays the local store address in a top banner, a welcome message that may be personalized to the user, and allows the user to select a number of in-store features. In this particular example, the in-store features include an in-store map that may guide the user to the books that are on sale, and the store's café menu. In some cases, after entering the store the user may purchase the eBooks at the discounted price in the store or at home as long as the 12 hours have not passed, while in other cases the user must purchase the eBooks through the bookstore's wireless network in order to redeem the discount. Requiring the user to purchase the eBook through the store's wireless network may decrease wait times at physical check-out lines and may also improve the user's purchase experience and encourage the user to stay in the bookstore longer, sample the eBook, sample other books, visit the bookstore café, etc.

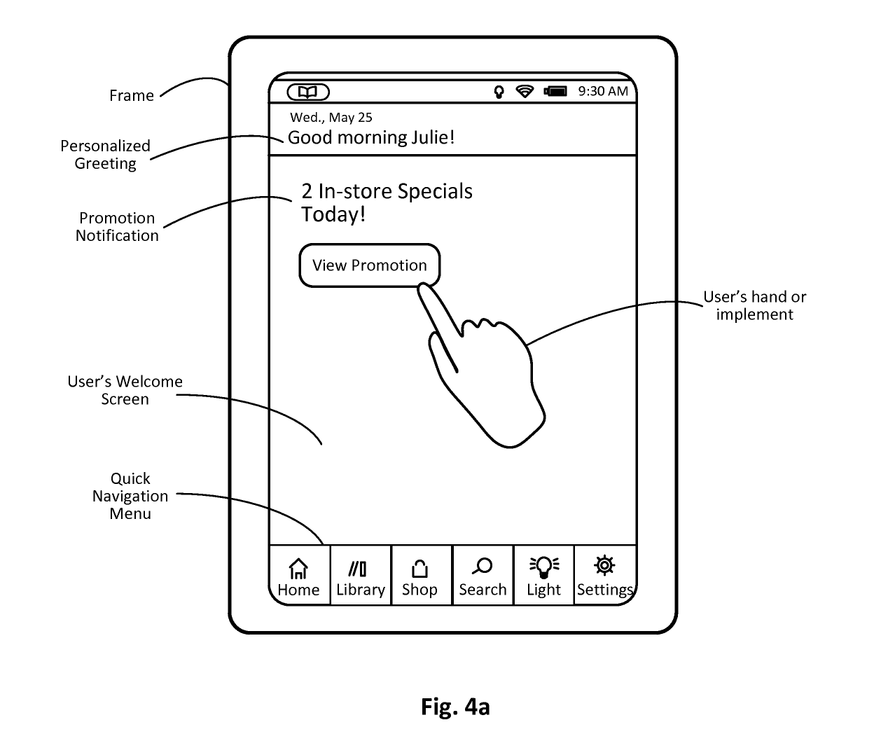

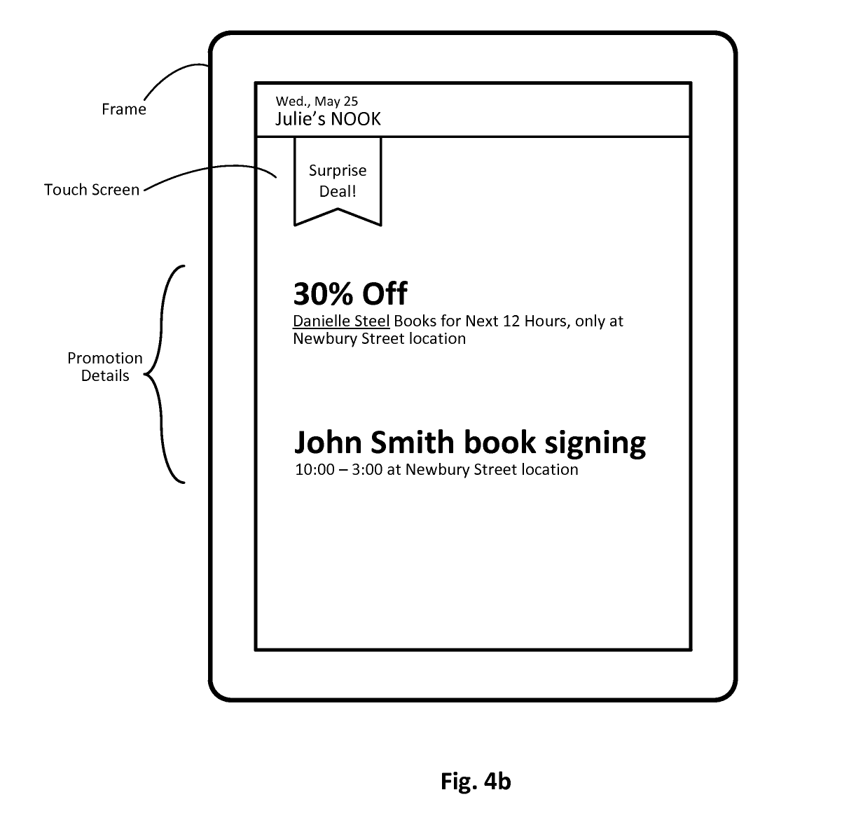

FIGS. 4a-b collectively illustrate an example in-store promotion mode that can be applied to a touch sensitive electronic device, in accordance with an embodiment of the present invention. Generally: FIG. 4a shows an electronic touch sensitive device displaying an example in-store promotion notification; and FIG. 4b shows an electronic touch sensitive device displaying the in-store promotion details.

FIG. 4a shows the device displaying a promotion notification to the user. In this example, the promotion notification is displayed on the user's welcome screen when the device is activated. In one embodiment, the device is connected to the Internet and can track in-store promotions online in order to notify the user of sales, book signings, or other in-store events at the user's local store. In this particular example, the promotion notification is configured to display on the user's personalized welcome screen along with the date, a personalized greeting, and the quick navigation menu. Furthermore, the promotion notification in this example embodiment is a generic notification that tells the user that two in-store specials are available today, and the user may select the touch screen UI button to view the details regarding the promotion.

FIG. 4b shows the device displaying the promotion details to the user after selecting the promotion notification from the user's welcome screen. In this example, the device is displaying the details regarding one book sale and one book-signing event. Specifically, for the next 12 hours there will be a 30% discount on all Danielle Steel books at the Newbury Street store, and there will be a book signing at the same store from 10:00 am to 3:00 pm. In this particular example, because the promotions involve sales of physical books and a book signing, the user is required to visit the physical store in order to redeem the promotion or attend the book signing. In other embodiments, the promotion details message may not include all the specifics regarding the promotion (like the example shown in FIG. 3a), and the user must visit the actual bookstore and connect the device to the store's wireless network in order to view the specifics of the promotion.

Methodology

FIG. 5 illustrates a method for providing an in-store promotion mode in an electronic touch screen device, in accordance with an embodiment of the present invention. This example methodology may be implemented, for instance, by the UI module of the example touch screen device shown in FIG. 2a, or the example touch screen device shown in FIG. 2b (e.g., with the UI provisioned to the client by the server). To this end, the in-store promotion mode can be implemented in software, hardware, firmware, or any combination thereof, as will be appreciated in light of this disclosure.

As can be seen, in this example case, the method starts by determining 501 the user's preferences. In one example embodiment, the user's preferences may be determined based on the user's reading history, search history, purchase history, prior content ratings, wish list, currently reading content, favorite authors list, browser behavior, or other features of the user's taste profile. The method may continue with checking 502 for local promotions relating to user's preferences. Local promotions may include eBook sales, book sales, magazine sales, author signings, book readings, or other events at the user's local store or other stores nearby. In some cases, the user may select a local store using an in-store promotion mode configuration sub-menu. In addition, or alternatively, the device may automatically determine the closest store to the user based on, for example, a local area network (LAN) to which the device is connected (e.g., by tracking an IP address associated with that LAN to a physical address or geolocation), a geolocation function of the device (e.g., GPS), a credit card address associated with the device, and/or any other suitable way to identify the location of the device. The method may continue with displaying 503 a promotion notification. In some cases, the promotion notification may include a pop-up message displayed on the device screen once an in-store promotion begins, a message displayed on the device's home screen or on the user's customizable welcome screen, or any other notification displayed to the user on the device screen. In some embodiments, the promotion notification may be accompanied by an animation or sound effect that may be user configurable or hard coded. In some embodiments, the promotion notification may be a generic message notifying the user of a sale or other event at a local store and requiring the user to enter the physical store in order to learn the details of the sale or event. In other embodiments, the promotion notification may include the details of a promotion but require the user to visit the physical store in order to redeem the promotion.

The method may continue with determining 504 whether the user has entered the local store with the device. If the user has not entered the store, the method may continue with displaying 505 an optional promotion reminder to the user. In some embodiments a promotion may last for only a limited time and such a promotion reminder may help the user take advantage of a local promotion before the promotion expires. The user may also indicate that he/she has no interest in the promotion, or otherwise dismiss the notification (e.g., click a Not Interested UI feature provided in the pop-up window). If the user has entered the store, the method may continue with displaying 506 the promotion details and allowing the user to redeem the promotion. In one particular embodiment, the initial promotion notification may only tell the user that a sale will be happening at the user's local store without providing all the details of the sale, and upon entering the store the details of which books are on sale and at what percent discount may be displayed when the user activates the device within the store. Once the user has entered the store and the device is connected to the store's wireless network the user may redeem the in-store promotion.

Numerous variations and embodiments will be apparent in light of this disclosure. One example embodiment of the present invention provides a device including a display for displaying digital content to a user and allowing user input. The device also includes a user interface including an in-store promotion mode configured to present on the display a promotion notification which alerts the user of an in-store promotion that may be redeemed using the device by visiting a physical retail store, the in-store promotion matching a taste profile that indicates interests of the user. In some cases, the in-store promotion includes at least one of an eBook sale, book sale, music sale, video sale, magazine sale, author signing, and/or book reading. In some cases, the in-store promotion includes a sale on digital content sold by the retail store and wherein the user can only redeem the sale within the retail store. In some cases, the retail store includes a specific store at a given physical address that is local to the user and the promotion is not offered to the general public. In some cases, the promotion notification includes a generic message notifying the user of the existence of a promotion, and wherein the in-store promotion mode is further configured to display a welcome message upon activating the device within the retail store, the message displaying all the details regarding the promotion. In some cases, the promotion notification provides a physical address for the retail store where the in-store promotion is taking place. In some cases, the promotion notification includes at least one of a pop-up window displayed to the user upon detecting an in-store promotion, a message displayed on the device's home screen, and/or a message displayed on a user's customizable welcome screen. In some cases, the in-store promotion mode is associated with a local retail store, and only promotion notifications relating to the local retail store are displayed. In some cases, the user's taste profile is determined based on at least one of the user's reading history, shopping cart, wish list, search history, purchase history, content ratings, favorite authors, favorite bands/musicians, favorite games, browser behavior, and/or event preferences. In some cases, the promotion notification includes an indication of the duration of the promotion. In some cases, the in-store promotion mode is further configured to display a promotion reminder prior to the expiration of an in-store promotion. In some cases, the device is an eBook reader, a mobile cell phone, a laptop, or a tablet.

Another example embodiment of the present invention provides a mobile computing system including a processor and a touch screen display for displaying content to a user and allowing user input, a processor, and a user interface including an in-store promotion mode executable on the processor and configured to display on the touch screen display a promotion notification which alerts the user of an in-store promotion that may be redeemed using the device by visiting a physical retail store, the in-store promotion mode further configured with a taste profile that indicates interests of the user and to match specific in-store promotions to the user based on the taste profile. In some cases, the user's taste profile is determined based on at least one of the user's reading history, shopping cart, wish list, search history, purchase history, content ratings, favorite authors, favorite bands/musicians, favorite games, browser behavior, and/or event preferences. In some cases, the promotion notification includes a generic message notifying the user of the existence of a promotion, and wherein the in-store promotion mode is further configured to display a welcome message upon activating the device within the retail store, the message displaying all the details regarding the promotion. In some cases, the in-store promotion mode is associated by the user with a local retail store, and wherein only promotion notifications relating to the local retail store are displayed.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to detect an in-store promotion matching a taste profile that indicates interests of a user of the electronic device, the in-store promotion being redeemable upon visiting a retail store with the electronic device, and display on the electronic device a promotion notification alerting the user of the in-store promotion. In some cases, a user's taste profile is determined based on at least one of the user's reading history, shopping cart, wish list, search history, purchase history, content ratings, favorite authors, favorite bands/musicians, favorite games, browser behavior, and/or event preferences. In some cases, an in-store promotion is detected by detecting in-store promotions at a local retail store associated with the user. In some cases, the promotion notification includes a generic message notifying the user of the existence of a promotion, and wherein the process is further configured to: display on the electronic device a welcome message upon activating the device within the retail store, the message displaying all the details regarding the promotion

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a display for displaying digital content to a user and allowing user input; and
a user interface including an in-store promotion mode configured to present on the display a promotion notification which alerts the user of an in-store promotion that may be redeemed using the device by visiting a physical retail store, the in-store promotion matching a taste profile that indicates interests of the user.

2. The device of claim 1 wherein the in-store promotion comprises at least one of an eBook sale, book sale, music sale, video sale, magazine sale, author signing, and/or book reading.

3. The device of claim 1 wherein the in-store promotion comprises a sale on digital content sold by the retail store and wherein the user can only redeem the sale within the retail store.

4. The device of claim 1 wherein the retail store comprises a specific store at a given physical address that is local to the user and the promotion is not offered to the general public.

5. The device of claim 1 wherein the promotion notification comprises a generic message notifying the user of the existence of a promotion, and wherein the in-store promotion mode is further configured to display a welcome message upon activating the device within the retail store, the message displaying all the details regarding the promotion.

6. The device of claim 1 wherein the promotion notification provides a physical address for the retail store where the in-store promotion is taking place.

7. The device of claim 1 wherein the promotion notification comprises at least one of a pop-up window displayed to the user upon detecting an in-store promotion, a message displayed on the device's home screen, and/or a message displayed on a user's customizable welcome screen.

8. The device of claim 1 wherein the in-store promotion mode is associated with a local retail store, and wherein only promotion notifications relating to the local retail store are displayed.

9. The device of claim 1 wherein the user's taste profile is determined based on at least one of the user's reading history, shopping cart, wish list, search history, purchase history, content ratings, favorite authors, favorite bands/musicians, favorite games, browser behavior, and/or event preferences.

10. The device of claim 1 wherein the promotion notification includes an indication of the duration of the promotion.

11. The device of claim 1 wherein the in-store promotion mode is further configured to display a promotion reminder prior to the expiration of an in-store promotion.

12. The device of claim 1 wherein the device is an eBook reader, a mobile cell phone, a laptop, or a tablet.

13. A mobile computing device, comprising:
a touch screen display for displaying content to a user and allowing user input;
a processor; and
a user interface including an in-store promotion mode executable on the processor and configured to display on the display a promotion notification which alerts the user of an in-store promotion that may be redeemed using the device by visiting a physical retail store, the in-store promotion mode further configured with a taste profile that indicates interests of the user and to match specific in-store promotions to the user based on the taste profile.

14. The device of claim 13 wherein the user's taste profile is determined based on at least one of the user's reading history, shopping cart, wish list, search history, purchase history, content ratings, favorite authors, favorite bands/musicians, favorite games, browser behavior, and/or event preferences.

15. The device of claim 13 wherein the promotion notification comprises a generic message notifying the user of the existence of a promotion, and wherein the in-store promotion mode is further configured to display a welcome message upon activating the device within the retail store, the message displaying all the details regarding the promotion.

16. The device of claim 13 wherein the in-store promotion mode is associated by the user with a local retail store, and wherein only promotion notifications relating to the local retail store are displayed.

17. A computer program product comprising a plurality of instructions non-transiently encoded thereon to facilitate operation of an electronic device according to the following process:
detect an in-store promotion matching a taste profile that indicates interests of a user of the electronic device, the in-store promotion being redeemable upon visiting a retail store with the electronic device; and
display on the electronic device a promotion notification alerting the user of the in-store promotion.

18. The computer program product of claim 17 wherein a user's taste profile is determined based on at least one of the user's reading history, shopping cart, wish list, search history, purchase history, content ratings, favorite authors, favorite bands/musicians, favorite games, browser behavior, and/or event preferences.

19. The computer program product of claim 17 wherein an in-store promotion is detected by detecting in-store promotions at a local retail store associated with the user.

20. The computer program product of claim 17 wherein the promotion notification comprises a generic message notifying the user of the existence of a promotion, and wherein the process is further configured to: display on the electronic device a welcome message upon activating the device within the retail store, the message displaying all the details regarding the promotion.
